(19) United States
(12) Patent Application Publication
(10) Pub. No.: US 2024/0179620 A1
(43) Pub. Date: May 30, 2024

(54) IN-VEHICLE RADIO DEVICE AND SERVICE CHANNEL SELECTION CANDIDATE PROVIDING METHOD

(71) Applicant: PANASONIC INTELLECTUAL PROPERTY MANAGEMENT CO., LTD., Osaka (JP)

(72) Inventors: Ryohei SHINDO, Tokyo (JP); Masaki KUNIMATSU, Tokyo (JP); Masataka YAMAMOTO, Kanagawa (JP)

(21) Appl. No.: 18/522,635

(22) Filed: Nov. 29, 2023

(30) Foreign Application Priority Data
Nov. 30, 2022 (JP) 2022-191771

(51) Int. Cl. H04W 48/18; H04W 72/0453

(52) U.S. Cl. CPC H04W 48/18; H04W 72/0453

(57) ABSTRACT

An in-vehicle radio device includes a memory storing a program, a processor coupled to the memory and performing processing by executing the program, and an antenna configured to receive radio signals. The program includes deriving preference information of a user based on service channel selection history of the user, calculating information indicating a size of a reception area for each of a plurality of services that are selectable by the radio signals received by the antenna, extracting one or more services recommended from the plurality of services that are selectable by the radio signals received by the antenna, based on the preference information and the information indicating the size of the reception area, and displaying the one or more extracted services on a screen.

### CROSS-REFERENCE TO RELATED APPLICATIONS

This application is based on and claims priority under 35 USC 119 from Japanese Patent Application No. 2022-191771 filed on Nov. 30, 2022, the contents of which are incorporated herein by reference.

### TECHNICAL FIELD

The present disclosure relates to an in-vehicle radio device and a service channel selection candidate providing method.

### BACKGROUND ART

In the related art, various communication devices are mounted on a vehicle, and are used by a passenger during traveling or the like. An example of such an in-vehicle communication device is an in-vehicle radio device. The in-vehicle radio device receives radio signals from a base station around the vehicle, and a user selects and uses a desired radio program from a plurality of radio programs.

On the other hand, various radio programs including analog radio and digital radio are provided from many base stations, and the user needs to select a program from the many radio programs. Therefore, it takes time to find out a desired program from many programs and select the program. For example, Patent Literature 1 discloses a configuration in which an in-vehicle channel selection device automatically selects a broadcast program according to a preference of a user without requiring the user to select a channel. Further, Patent Literature 2 discloses a configuration in which a moving body that can receive and provide a program extracts a program that can be viewed stably until an end of a broadcast based on a travel route and provides the program to a user.

### CITATION LIST

### Patent Literature

Patent Literature 1: WO2009/128121
Patent Literature 2: JP2016-092579A

### SUMMARY OF INVENTION

For example, a digital audio broadcast (DAB) standard is known as one of a digital radio standard. In transmission of such a signal, the number of radio programs (hereinafter referred to as “services”) broadcast concurrently from one base station is on the rise due to signal densification through orthogonal frequency-division multiplexing (OFDM) transmission and the like. Further, there are a plurality of base stations around the vehicle, each of which broadcasts a plurality of services, and the vehicle can receive and use a large number of services. Furthermore, in the case of crossing regions or countries, the same content of the services may be broadcasted from different base stations, so that options as channel selection candidates increase. In such a situation, a burden of the user selecting a desired service from the plurality of services is also on the rise.

In the configuration of Patent Literature 2, since determination is performed based on only a reception level, when a large number of programs are in a provided list, the user will continue to be burdened with channel selection. Further, in Patent Literature 2, an estimated reception level along a movement route to a destination is obtained from a database on a cloud server, and a list of programs that can be viewed to the end is preferentially displayed and provided to the user. At this time, since access to the cloud server is required at the time of prediction, a communication device other than a receiver that can receive broadcast waves is required.

In view of the above problems, an object of the present disclosure is to provide, with a simple configuration, a user-preferred service candidate while reducing a burden of channel selection of a user when the user selects a digital radio service.

The present disclosure provides an in-vehicle radio device including a memory in which a program is stored, a processor coupled to the memory and configured to perform processing by executing the program, and an antenna configured to receive radio signals. The processing includes deriving preference information of a user based on service channel selection history of the user, calculating information indicating a size of a reception area for each of a plurality of services that are selectable by the radio signals received by the antenna, extracting one or more services recommended from the plurality of services that are selectable by the radio signals received by the antenna, based on the preference information and the information indicating the size of the reception area, and displaying the one or more extracted services on a screen.

Additionally, the present disclosure provides a service channel selection candidate providing method including deriving preference information of a user based on service channel selection history of the user, calculating information indicating a size of a reception area for each of a plurality of services that are selectable by radio signals received by an antenna, extracting one or more services recommended from the plurality of services that are selectable by the radio signals received by the antenna based on the preference information and the information indicating the size of the reception area, and displaying the one or more extracted services on a screen.

Any combination of the above components, and any conversion of the expressions of this disclosure among method, device, system, storage medium, computer program, and the like, is also valid as an aspect of the disclosure.

According to the present disclosure, it is possible to provide, with a simple configuration, a user-preferred service candidate while reducing a burden of channel selection of a user when the user selects a digital radio service.

### BRIEF DESCRIPTION OF DRAWINGS

FIG. 1 is a diagram illustrating an example of a hardware configuration of an in-vehicle radio device according to a first embodiment.

FIG. 2 is a block diagram illustrating an example of a functional configuration of the in-vehicle radio device according to the first embodiment.

FIGS. 3A and 3B are diagrams illustrating an example of service display in the in-vehicle radio device according to the first embodiment.

FIG. 4 is a conceptual diagram illustrating base stations and reception areas of radios around a vehicle.

FIG. 5 is a diagram illustrating a configuration example of service information according to the first embodiment.

FIG. 6 is an overall flowchart of a service channel selection candidate providing process according to the first embodiment.

FIGS. 7A and 7B are flowcharts of a UI display process (having a first recommendation function) according to the first embodiment.

FIG. 8 is a flowchart of a UI display process (having a second recommendation function) according to the first embodiment.

FIGS. 9A, 9B, and 9C are diagrams illustrating examples of UI display according to the first embodiment.

FIGS. 10A and 10B are diagrams illustrating another example of UI display according to an embodiment of the present disclosure.

FIGS. 11A and 11B are diagrams illustrating another example of UI display according to an embodiment of the present disclosure.

### DESCRIPTION OF EMBODIMENTS

Hereinafter, embodiments that specifically disclose an in-vehicle radio device and a service channel selection candidate providing method according to the present disclosure will be described in detail with reference to the accompanying drawings as appropriate. However, unnecessarily detailed description may be omitted. For example, detailed description of well-known matters or redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matters described in the claims.

### First Embodiment

An in-vehicle radio device according to the present embodiment is mounted on a vehicle, for example, and is configured to be operable by a user. The in-vehicle radio device may be configured as a single device, or may be configured as one function of a navigation device. Further, the term “vehicle” to be described below is not limited to an ordinary passenger vehicle, and may be any moving body such as a two-wheeled vehicle, a bus, or a truck.

### (Device Configuration)

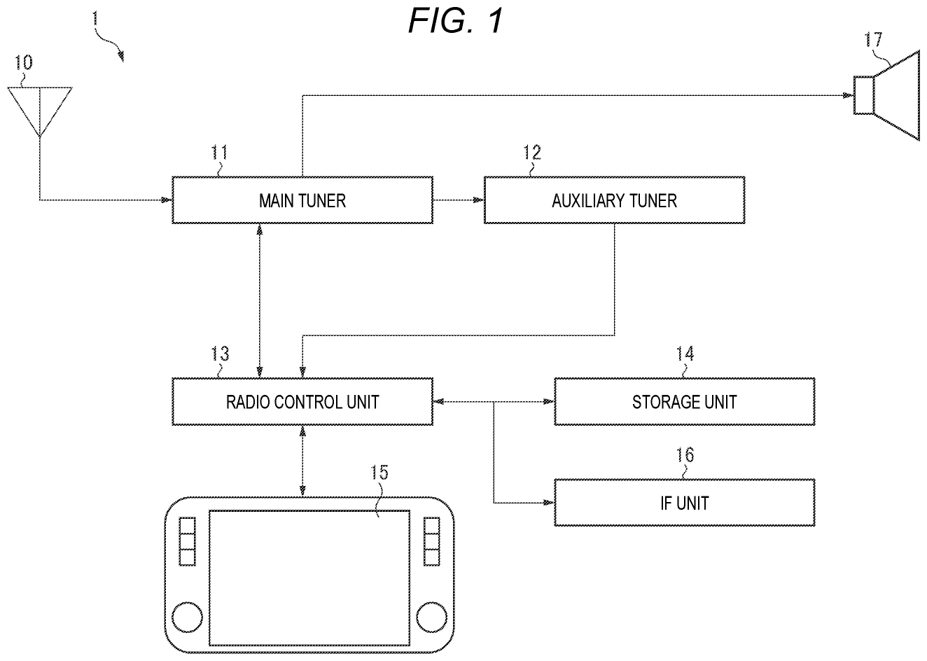

FIG. 1 is a block diagram illustrating a configuration example of an in-vehicle radio device 1 according to the present embodiment. In FIG. 1, arrows indicate an example of a flow of a signal to each block. A configuration illustrated in FIG. 1 is an example. Therefore, a portion other than the configuration shown in FIG. 1 may be further provided. Further, the in-vehicle radio device 1 may be configured to share a function by cooperating with the vehicle (not shown) when the in-vehicle radio device 1 is mounted on the vehicle.

The in-vehicle radio device 1 receives digital radio signals (hereinafter referred to as “radio signals”) corresponding to one or more services, and outputs a service selected from the one or more services by sound. The in-vehicle radio device 1 may be fixed to the vehicle, or may be detachably attached to the vehicle.

An antenna 10 receives radio signals in a predetermined frequency band transmitted from nearby base stations and provides the radio signals to each tuner. In the present embodiment, description will be made on an assumption that the radio signal is information based on a digital audio broadcasting (DAB) standard. Further, the DAB standard is defined, for example, in ETS400401 (ETS: European Technical Standard).

A main tuner 11 receives (filters) a service of a frequency designated by a channel selected by the user received via a radio control unit 13 among the radio signals received by the antenna 10, and causes the speaker 17 to output sound. A known method may be used for digital radio signal processing (extraction of a carrier frequency band, demodulation of a signal, decoding of a demodulated signal, and the like) in each tuner, and detailed description thereof will be omitted here. Further, the main tuner 11 appropriately notifies the radio control unit 13 of information on a currently selected service. Here, the service information passed from the main tuner 11 to the radio control unit 13 includes a frequency of the currently selected service and DAB data. The DAB data may include a genre, a country code, a delivery area code, network station information, and the like.

An auxiliary tuner 12 specifies services other than a service extracted by the main tuner 11, generates a list of selectable services, and provides the list to the radio control unit 13. The list here may include frequencies of the selectable services and DAB data. Therefore, the main tuner 11 and the auxiliary tuner 12 provide the radio control unit 13 with information on the currently selected service and the selectable services.

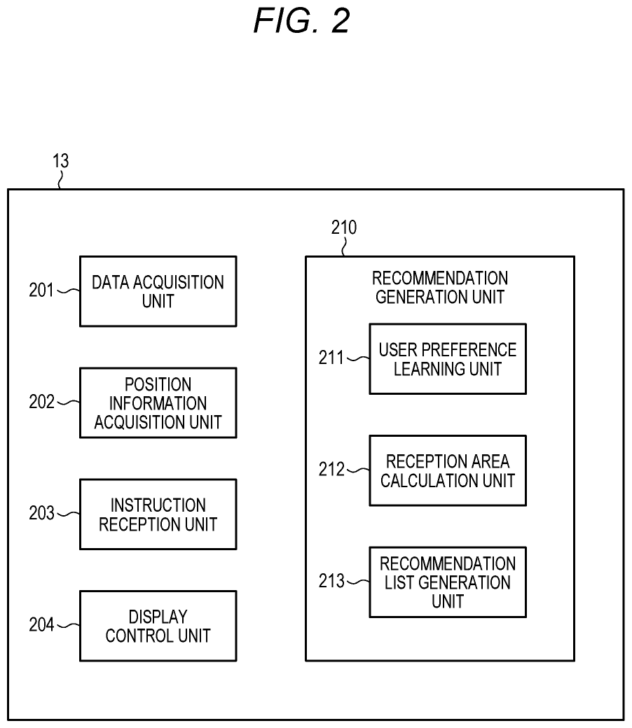

The radio control unit 13 performs overall control of the in-vehicle radio device 1 and provides various functions to be described later. A storage unit 14 includes, for example, a read only memory (ROM), a flash memory, or the like, which is a volatile/nonvolatile storage device, and stores programs and data for providing the functions of the in-vehicle radio device 1. A user interface (UI) unit 15 has functions as a display unit and an operation unit, receives operations from the user, and displays various screens to be described later. The in-vehicle radio device 1 includes Random Access Memory (RAM) that is not shown in figures. The radio control unit 13 is, for example, a processor. The radio control unit 13 is performed as a data acquisition unit 201, position information receiving unit 202, an instruction reception unit 203, a display control unit 204, a recommendation generation unit 210, a user preference learning unit 211, a reception area calculation unit 212, and a recommendation list generation unit 213 which are shown in FIG. 2, for example, by developing the programs stored in the ROM of the storage unit 14 on the RAM.

An interface (IF) unit 16 is an interface with an external device, and is used, for example, when performing cooperation with the vehicle on which the in-vehicle radio device 1 is mounted. For example, the in-vehicle radio device 1 may be configured to receive position information of the vehicle via the IF unit 16 or to receive power supply from a power source (battery) (not shown) provided on the vehicle. The position information may be position measurement information of a global navigation satellite system (GNSS) represented by a global positioning system (GPS), and may include latitude, longitude, altitude, and the like. Alternatively, information on a planned travel route may be obtained from a navigation system mounted on the vehicle.

### (Functional Configuration)

FIG. 2 is a block diagram illustrating a configuration example of functions provided by the radio control unit 13 of the in-vehicle radio device 1 according to the present embodiment. For example, the radio control unit 13 may read and execute the program or the data stored in the storage unit 14 to implement each unit illustrated in FIG. 2. Further, the configuration illustrated in FIG. 2 is an example, and one part may be divided into a plurality of parts, or a plurality of parts may be integrated into one. Here, only parts related to the functions according to the present embodiment are shown, and the radio control unit 13 may further provide other functions.

The radio control unit 13 includes a data acquisition unit 201, a position information receiving unit 202, an instruction reception unit 203, a display control unit 204, and a recommendation generation unit 210. The recommendation generation unit 210 includes a user preference learning unit 211, a reception area calculation unit 212, and a recommendation list generation unit 213.

The data acquisition unit 201 receives various data based on the radio signals received by the antenna 10 via the main tuner 11 and the auxiliary tuner 12. The received data is stored in the storage unit 14 and managed. As described above, the received data may be managed in association with information on the currently selected service or the selectable services. The data acquisition unit 201 may perform a process of periodically deleting the stored data from the storage unit 14.

The position information receiving unit 202 receives the position information from the vehicle via the IF unit 16. As the position information, the information on the planned travel route as described above or information on a current position may be obtained. The instruction reception unit 203 receives an instruction from the user via the UI unit 15. The instruction here includes, for example, service channel selection and the like. The display control unit 204 controls display for providing various types of information to the user via the UI unit 15, such as a UI screen to be described later.

The recommendation generation unit 210 extracts a service from a plurality of services according to a preference of the user, and generates a list of services to be provided to the user (hereinafter also referred to as a “recommendation list”). The user preference learning unit 211 learns the preference (service channel selection tendency) of the user based on service channel selection history of the user and derives user preference information. In the present embodiment, as a learning method, a configuration based on statistics of the channel selection history of the user will be described as an example. However, the present invention is not limited thereto, and for example, a configuration in which the user preference information is derived using a method such as machine learning may be used. In this case, for example, the configuration may be achieved by to generating, using any learning algorithm, a learned model in which the DAB data of the service selected by the user and the selectable services is input and one or more services is output. The reception area calculation unit 212 calculates information (hereinafter also referred to as “reception area information”) on a reception area of currently selectable services based on the data received by the data acquisition unit 201. A specific example of the calculation of the reception area information will be described later. The recommendation list generation unit 213 generates a recommendation list to be provided to the user based on the user preference information learned by the user preference learning unit 211, the reception area information calculated by the reception area calculation unit 212, and the position information of the in-vehicle radio device (vehicle). The generated recommendation list is provided to the user by the display control unit 204 via the UI unit 15.

### (Usage Environment of In-Vehicle Radio Device)

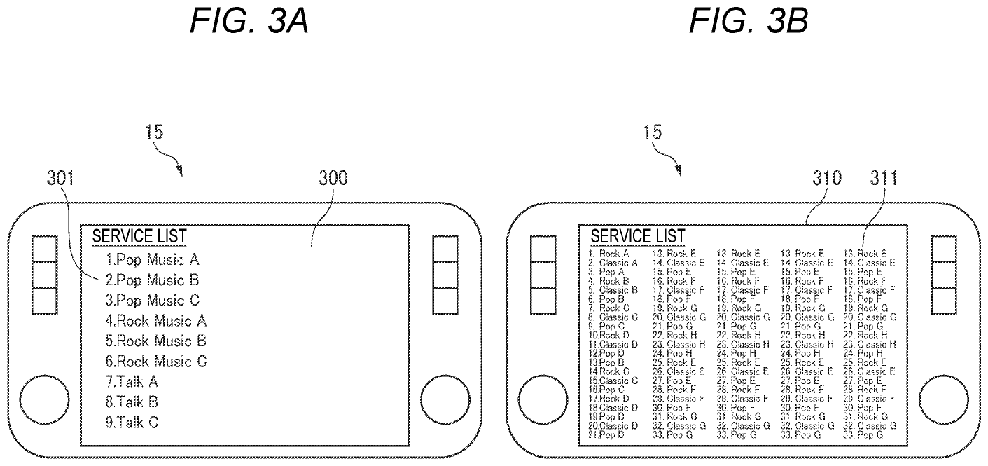

Here, an environment in which the in-vehicle radio device is used and a problem in a configuration in the related art will be described with an example. FIGS. 3A and 3B are diagrams illustrating configuration examples of the UI screen. As described above, in radio broadcasting in recent years, it is possible to broadcast a plurality of services concurrently from one base station. For example, it is assumed that the vehicle is located within a reception area of one base station. Under such a situation, a plurality of selectable services can be displayed as shown in FIG. 3A by radio signals transmitted from the one base station.

A UI screen 300 shown in FIG. 3A shows a list 301 of services. Here, all the selectable services are displayed in a predetermined arrangement order. In this way, in the case in which the vehicle is located within the reception area of the one base station, it takes less time and effort to select a selectable service, and visibility can be relatively maintained when the selectable services are collectively displayed.

On the other hand, when the vehicle is located within an overlapping reception area of a plurality of base stations, the number of selectable services increases rapidly. For example, in the case of a configuration in which a list of about 10 services is displayed on one screen and the screen is switched by scrolling, the display can be made as shown in FIG. 3A. However, a time and effort for selecting a channel while scrolling the screen increases as the number of services increases. On the other hand, FIG. 3B shows an example of the UI screen in the case in which the plurality of selectable services are displayed when the vehicle is located within the reception areas of the plurality of base stations. A list 311 of the selectable services is displayed on the UI screen 310. As shown in FIG. 3B, when the selectable services are collectively displayed on one screen, a time and effort for switching the screen can be saved, but the visibility for the user decreases, and as a result, convenience in searching for and selecting the desired service decreases.

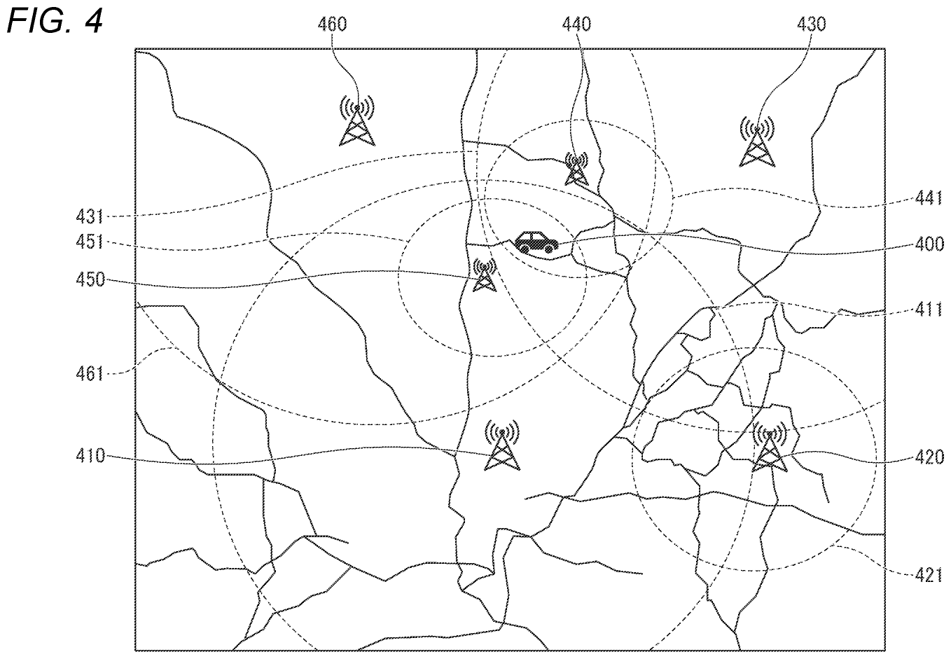

FIG. 4 is a conceptual diagram illustrating reception areas of the radio signals in the base stations around the in-vehicle radio device 1 according to the present embodiment. In a certain area, a vehicle 400 indicates a position of the vehicle on which the in-vehicle radio device 1 is mounted. Further, six base stations 410, 420, 430, 440, 450, and 460 that broadcast the radio signals exist around the vehicle 400. Reception areas 411, 421, 431, 441, 451, and 461 indicate reception areas in which the radio signals from the six base stations 410, 420, 430, 440, 450, and 460 can be received, respectively. In practice, the reception areas may fluctuate due to factors such as topography.

For example, it is assumed that the base stations 410, 430, and 460 are base stations for national broadcasting, and the base stations 420, 440, and 450 are base stations for commercial broadcasting. In other words, in the present embodiment, service broadcasting entities can be divided into national broadcasters and a commercial broadcasters. In general, the base station for national broadcasting has a wider reception area (more base stations). Although an example in which the broadcasting is divided into national broadcasting and commercial broadcasting is shown here, if more detailed classifications can be specified from the radio signals, three or more classifications may be used in the broadcasting entity. As shown in FIG. 4, a plurality of base stations are present in a certain area, and provide different reception areas. In the example of FIG. 4, since the vehicle 400 is positioned within an overlapping reception area of the five base stations 410, 430, 440, 450, and 460, there is a correspondingly large number of selectable services. As a result, in a configuration in which a channel is selected while switching the screens for many services, or in a configuration in which all selectable services are displayed collectively as shown in FIG. 3B, the user takes the time and effort to select and use one desired service among these services.

One object of the present embodiment is to prevent such complicated display and reduce the burden of the service channel selection performed by the user.

### (Service Information)

Hereinafter, information related to the service used in the present embodiment (hereinafter, referred to as “service information”) will be described. The service information is received based on the radio signal received by the antenna 10, and includes various items of data. These correspond to a part or all of the DAB data of the currently selected service or selectable services formed by the main tuner 11 and the auxiliary tuner 12. Here, the description will be made focusing on the items used in the present embodiment.

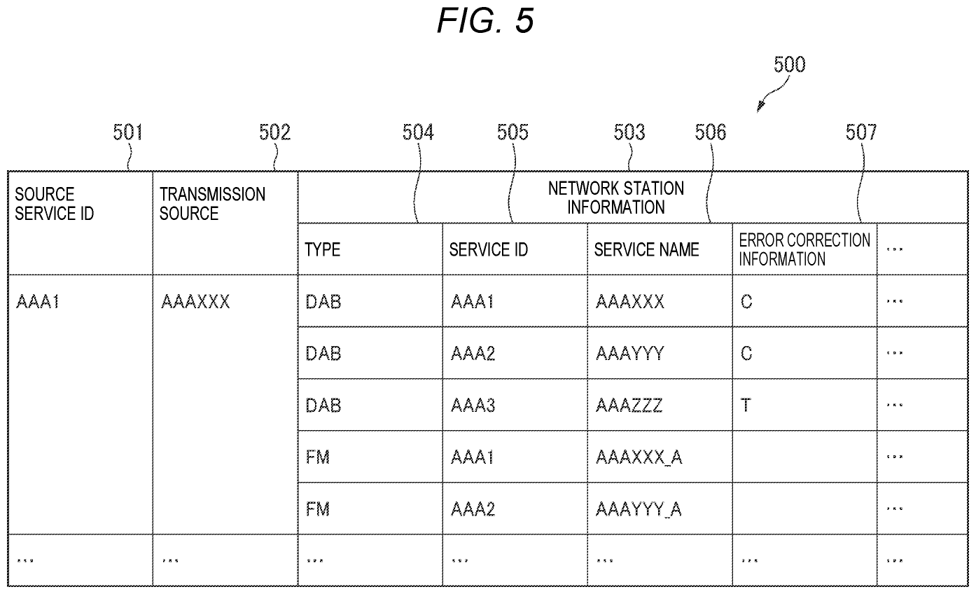

FIG. 5 is a configuration example of the service information corresponding to one service. There are a master station that provides the service and a slave station that belongs to the same network as the master station and broadcasts a similar service. Here, the slave station is also referred to as a network station. The master station and the slave station are convenient expressions, and a relationship may be changed according to a positional relationship of transmission and reception of the radio signal. Therefore, the relationship is not limited. The service information includes items of a source service ID 501, a transmission source 502, and network station information 503. The source service ID 501 is identification information for uniquely indicating a service in the master station. The transmission source 502 indicates a base station of the transmission source of the service.

The network station information 503 further includes a type 504, a service ID 505, a service name 506, and error correction information 507. The type 504 indicates a standard of the radio signal. For example, “DAB” may be set for a digital radio, and “FM” may be set for a FM radio. The service ID 505 is identification information for uniquely indicating a service in the network station. In the case of a radio signal directly transmitted by the master station, a value of the source service ID 501 may match a value of the service ID 505. The service name 506 indicates information of a service name freely set for each network station. In the error correction information 507, a standard or the like related to error correction used for transmission of a radio signal by the network station is set.

In the present embodiment, the recommendation list to be provided to the user is formed using the above-described service information. More detailed processing will be described later together with a flowchart.

### (Process Flow)

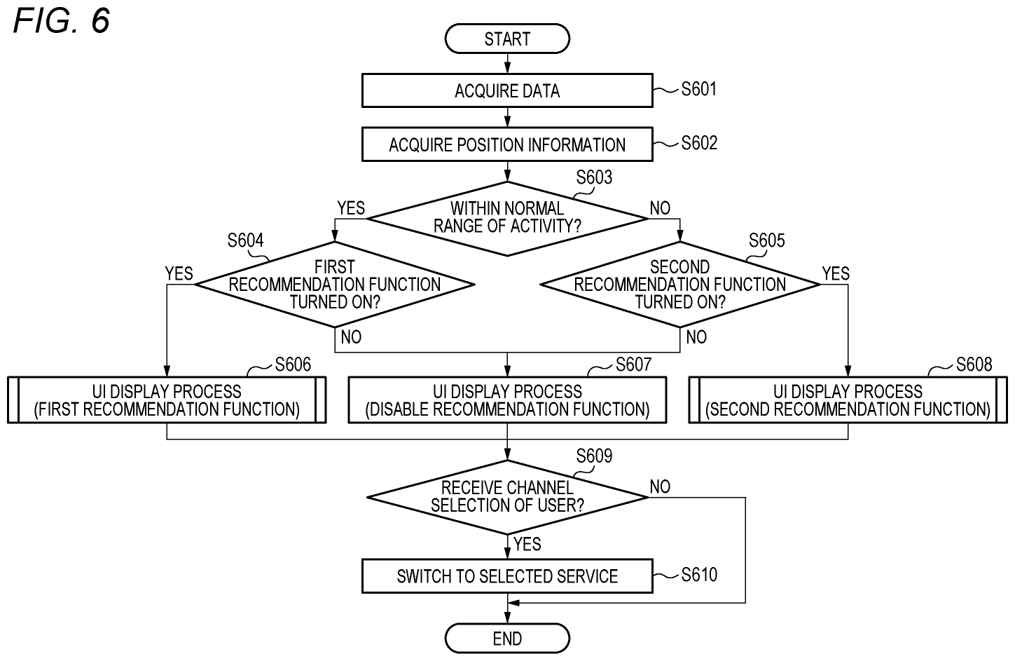

A flowchart of a service channel selection candidate providing process according to the present embodiment will be described with reference to FIGS. 6 to 8. This process flow may be achieved by causing the radio control unit 13 to read and execute the program or the like stored in the storage unit 14 to operate as each unit illustrated in FIG. 2. Here, in order to simplify the description, a processing entity is collectively shown as the radio control unit 13. This process flow may be started when the in-vehicle radio device 1 is activated by the user or when operation of the vehicle is started.

In the present embodiment, it is assumed that a recommendation function (hereinafter also referred to as a “first recommendation function”) provided by the user of the in-vehicle radio device 1 within a normal range of activity, and a recommendation function (hereinafter also referred to as a “second recommendation function”) provided outside the normal range of activity (for example, a travel destination, long-distance travel, or the like) can be provided as recommendation functions. The user can freely set whether to use these recommendation functions.

It is assumed that the radio signals transmitted from the respective base stations are received and managed as appropriate before the start of this process flow or concurrently. A management target here includes history data for a service that has been selected and output by the user in the past.

The radio control unit 13 receives data based on the radio signal received via the antenna 10 (step S601). Specifically, the information of the service currently selected by the main tuner 11 and the information of the selectable service generated by the auxiliary tuner 12 are received, each including the DAB data.

The radio control unit 13 receives the position information of the vehicle (step S602). As described above, the position information may be received by a GPS sensor (not shown) or the like in the vehicle.

The radio control unit 13 determines whether the current position is within the normal range of activity based on the position information received in step S602 (step S603). More specifically, the radio control unit 13 may record a range in which the vehicle is frequently located as the normal range of activity based on past position information of the vehicle. Further, the radio control unit 13 may determine whether the vehicle is located within the normal range of activity by comparing this range with the current position. When the vehicle is within the normal range of activity (step S603: YES), the process of the radio control unit 13 proceeds to step S604. On the other hand, when the vehicle is outside the normal range of activity (step S603: NO), the process of the radio control unit 13 proceeds to step S605.

The radio control unit 13 determines whether the recommendation function (first recommendation function) within the normal range of activity is set to ON (step S604). ON/OFF of the first recommendation function can be freely set by the user. When the first recommendation function is set to ON (step S604: YES), the process of the radio control unit 13 proceeds to step S606. On the other hand, when the first recommendation function is set to OFF (step S604: NO), the process of the radio control unit 13 proceeds to step S607.

The radio control unit 13 determines whether the recommendation function (second recommendation function) outside the normal range of activity is set to ON (step S605). ON/OFF of the second recommendation function can be freely set by the user. When the second recommendation function is set to ON (step S605: YES), the process of the radio control unit 13 proceeds to step S608. On the other hand, when the second recommendation function is set to OFF (step S605: NO), the process of the radio control unit 13 proceeds to step S607.

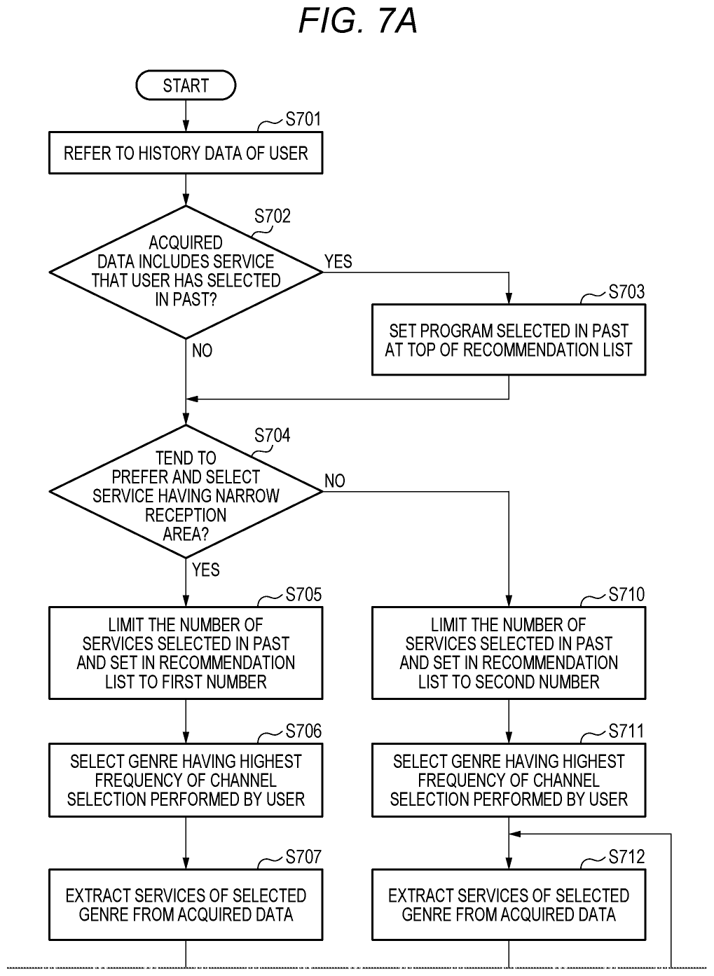

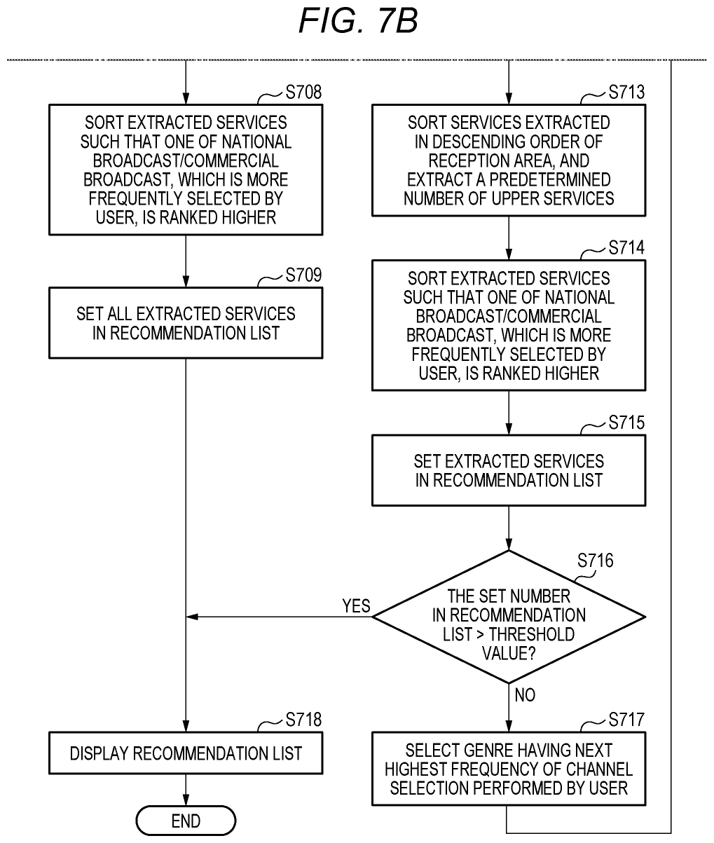

The radio control unit 13 performs a UI display process in which the first recommendation function is enabled (step S606). Details of this step will be described later with reference to FIGS. 7A and 7B. After this step ends, the process of the radio control unit 13 proceeds to step S609.

The radio control unit 13 performs a UI display process in which the first and second recommendation functions are disabled (step S607). In this case, for example, a list of services is displayed based on the received radio signals by the configuration of the UI screen as shown in FIGS. 3A and 3B. After this step ends, the process of the radio control unit 13 proceeds to step S609.

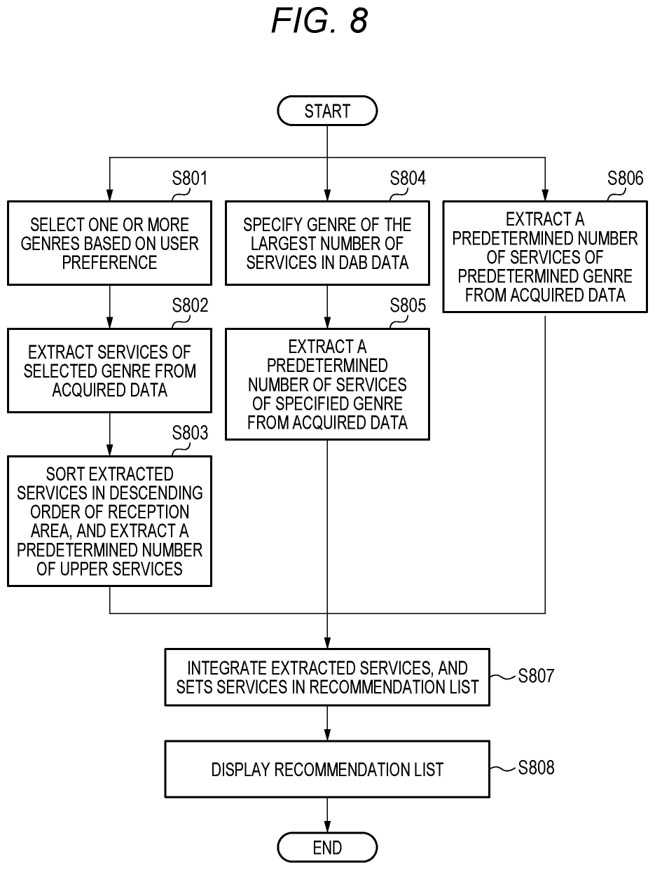

The radio control unit 13 performs a UI display process in which the second recommendation function is enabled (step S608). Details of this step will be described later with reference to FIG. 8. After this step ends, the process of the radio control unit 13 proceeds to step S609.

The radio control unit 13 determines whether new service channel selection is received from the user via the UI unit 15 (step S609). When the new service channel selection is received (step S609: YES), the process of the radio control unit 13 proceeds to step S610. On the other hand, when the new service channel selection is not received (step S609: NO), the process flow ends. Even if the new service channel selection is not received, when there is the currently selected service, the output may be continued. Further, when this step ends, this process flow may be continued until a stop instruction or the like of the user is executed.

The radio control unit 13 instructs the main tuner 11 to switch the output to the service selected by the user (step S610). When the switching is completed, information on the service being selected is received from the main tuner 11. Further, information on the selectable services is newly received from the auxiliary tuner 12. Furthermore, the history data of the user will be updated with the new service channel selection. Then, this process flow ends. Further, when this step ends, this process flow may be continued until a stop instruction or the like of the user is executed.

### (UI Display Process: First Recommendation Function)

FIGS. 7A and 7B are flowcharts illustrating a detailed process of step S606 in the process flow of FIG. 6.

The radio control unit 13 refers to the history data of the user and receives the user preference information (step S701). For example, the radio control unit 13 refers to a preferred service or genre of the user based on a selection frequency of the genre of the service selected by the user, a total time during which the user has selected the service, or the like. As the user preference information, a statistical value or the like may be calculated in advance from the history data, and may be updated as appropriate.

The radio control unit 13 determines whether the data received in step S601 of FIG. 6 includes the service that the user has selected in the past (step S702). When the data includes the service selected in the past (step S702: YES), the process of the radio control unit 13 proceeds to step S703. On the other hand, when the data does not include the service selected in the past (step S702: NO), the process of the radio control unit 13 proceeds to step S704.

The radio control unit 13 extracts the service selected by the user in the past from the received data, and sets the service to be displayed at the top of the recommendation list (step S703). At this time, the service may be set after the recommendation list is initialized. Further, when there are a plurality of services selected in the past, a predetermined number of services may be extracted and set in descending order of a frequency of channel selection. Furthermore, the process of the radio control unit 13 proceeds to step S704.

The radio control unit 13 determines whether the user tends to prefer and select a service having a narrow reception area (step S704). Here, determination of a size of the reception area according to the present embodiment will be described with reference to FIG. 5. As shown in FIG. 5, the network station information 503 of service information 500 includes the service ID 505. Focusing on this service ID 505, the more the services ID 505 associated with one service (one source service ID 501), the more network stations there are. That is, the one service can be treated as having a wide reception area that can be received. Conversely, the smaller the number of services ID 505, the narrower the reception area can be treated. In the present embodiment, this information is used as an index to determine whether the reception area for a certain service is wide or narrow. As for the number of network stations when the size of the reception area is determined, the total number of all network stations may be used, or the number of the types 504 corresponding to the digital radio of which a value is only “DAB” may be used.

Information for determining the size of the reception area is not limited to the above information, and other information may be used. For example, as shown in FIG. 5, the network station information 503 of the service information 500 includes the error correction information 507. Since the standard used for the error correction can be identified from the error correction information 507, if the standard is more reliable, the reception area may be treated as wider. Furthermore, the size of the reception area may be determined by combining information related to radio signal transmission and reception, such as a high signal level of a radio signal and a small distance attenuation.

Therefore, from the statistics of the service information indicated by the history data of the user, it is possible to calculate the size of the reception area of the service that the user tends to select. Further, the size of the reception area can be used as an index for specifying popularity of the service. Whether a service having the narrow reception area is preferred may be determined based on a most recent service selected in the past, or may be determined based on results of all channel selections. Alternatively, the determination may be made based on a ratio of channel selection history of services having a wide reception area to channel selection history of services having a narrow reception area. When the user tends to prefer and select the service having the narrow reception area (step S704: YES), the process of the radio control unit 13 proceeds to step S705. When the user tends not to prefer and select the service having the narrow reception area (step S704: NO), the process of the radio control unit 13 proceeds to step S710.

The radio control unit 13 limits the number of past services set in the recommendation list to a first number (step S705). The first number may be defined in advance, and may be set to, for example, “4”. When the number of services selected in the past set in the recommendation list in step S703 is smaller than the first number, a limiting process may be omitted.

Based on the history data of the user, the radio control unit 13 selects a genre having a highest frequency of channel selection performed by the user (step S706).

The radio control unit 13 extracts services of the genre selected in step S706 from the data based on the received radio signal (step S707).

The radio control unit 13 sorts the services extracted in step S707 such that one of a national broadcast/a commercial broadcast, which is more frequently selected by the user, is ranked higher (step S708). For the determination here, based on information of the service selected in the past, the broadcasting entity that the user tends to select may be specified, and a sorting criterion may be determined based on this.

The radio control unit 13 sets all the services sorted in step S708 in the recommendation list (step S709). At this time, the sorted services are set following the service already set at the top. Then, the process of the radio control unit 13 proceeds to step S718.

The radio control unit 13 limits the number of past services set in the recommendation list to a second number (step S710). The second number may be defined in advance and is a number smaller than the first number used in step S705. For example, “2” or the like may be set as the second number. When the number of services selected in the past set in the recommendation list in step S703 is smaller than the second number, a limiting process may be omitted.

Based on the history data of the user, the radio control unit 13 selects the genre having the highest frequency of channel selection performed by the user (step S711).

The radio control unit 13 extracts the services of the genre selected in step S711 from the data based on the received radio signal (step S712).

The radio control unit 13 sorts the services extracted in step S712 in descending order of the reception area, and extracts a predetermined number of upper services (step S713). The size of the reception area may be specified by calculating for each service in the same manner as the method described above.

The radio control unit 13 sorts the services extracted in step S713 such that one of the national broadcast/the commercial broadcast, which is more frequently selected by the user, is ranked higher (step S714). For the determination here, based on information of the service selected in the past, the broadcasting entity that the user tends to select may be specified, and a sorting criterion may be determined based on this.

The radio control unit 13 sets all the services sorted in step S714 in the recommendation list (step S715). At this time, the sorted services are set following the service already set at the top. Then, the process of the radio control unit 13 proceeds to step S716.

The radio control unit 13 determines whether the number of services set in the recommendation list exceeds a predetermined threshold value (step S716). The threshold value may be defined in advance or freely set by the user. When the set number exceeds the threshold value (step S716: YES), the process of the radio control unit 13 proceeds to step S718. On the other hand, when the set number does not exceed the threshold value (step S716: NO), the process of the radio control unit 13 proceeds to step S717.

The radio control unit 13 selects a genre having a high frequency of channel selection performed by the user, next to the currently selected genre (step S717). Further, the process of the radio control unit 13 returns to step S712, and the process is repeated until the number of services set in the recommendation list reaches the threshold value.

The radio control unit 13 displays the recommendation list via the UI unit 15 (step S718). Further, this process flow ends, and the process returns to the process in FIG. 6.

### (UI Display Process: Second Recommendation Function)

FIG. 8 is a flowchart illustrating a detailed process of step S608 in the process flow of FIG. 6. FIG. 8 illustrates an example in which, when a recommended service is extracted, processes based on a plurality of criteria are concurrently performed, but these processes may be performed sequentially. In the present embodiment, the service to be recommended is extracted based on three criteria, that is, recommendation based on a user preference, recommendation based on the number of services, and recommendation from a predetermined genre. The criteria are not limited to the three criteria, and two of these criteria may be used, or four or more criteria may be used.

The radio control unit 13 refers to the history data of the user and selects one or more genres having a high frequency of selection from service genres that the user has selected in the past (step S801). For example, the radio control unit 13 selects a user-preferred genre based on the selection frequency of the genre of the service selected by the user, the total time during which the user has selected the service, and the like. The history data here may be configured such that the statistical value or the like is calculated in advance and updated as appropriate. Here, the number of genres selected may be all genres that have been selected in the past for a number of times exceeding a fixed value, or may be the most frequently selected genre.

The radio control unit 13 extracts services corresponding to the genre selected in step S801 from the data received in step S601 of FIG. 6 (step S802).

The radio control unit 13 sorts the services extracted in step S802 in descending order of the reception area, and extracts a predetermined number of upper services (step S803). The predetermined number may be set in advance. Further, as described above, information related to the size of the reception area may be statistically calculated based on the service information. Further, the process of the radio control unit 13 proceeds to step S807.

The radio control unit 13 specifies the genre of the largest number of services in the data received in step S601 of FIG. 6 (step S804).

The radio control unit 13 extracts a predetermined number of services of the genre specified in step S804. The extraction here may be performed, for example, in such a manner that the services are arranged in a predetermined sorting order and the upper services are extracted, or the services may be randomly extracted (step S805). Further, the process of the radio control unit 13 proceeds to step S807.

The radio control unit 13 extracts a predetermined number of services of a predetermined genre from the data received in step S601 of FIG. 6 (step S806). The predetermined genre may be, for example, a genre that provides information (travel information, sightseeing information, weather information, and the like) for an area specified based on a current location of the vehicle. The genres selected in steps S801, S804, and S806 may be controlled differently, or may be controlled to allow overlapping. Further, the process of the radio control unit 13 proceeds to step S807.

The radio control unit 13 integrates the services extracted in steps S803, S805, and S806, and sets the services in the recommendation list (step S807). A setting order in the recommendation list here may be set by the user, or a sorting order may be defined in advance.

The radio control unit 13 displays the recommendation list set in step S807 via the UI unit 15 (step S718). Further, this process flow ends, and the process returns to the process in FIG. 6.

### (Display Example of Recommendation List)

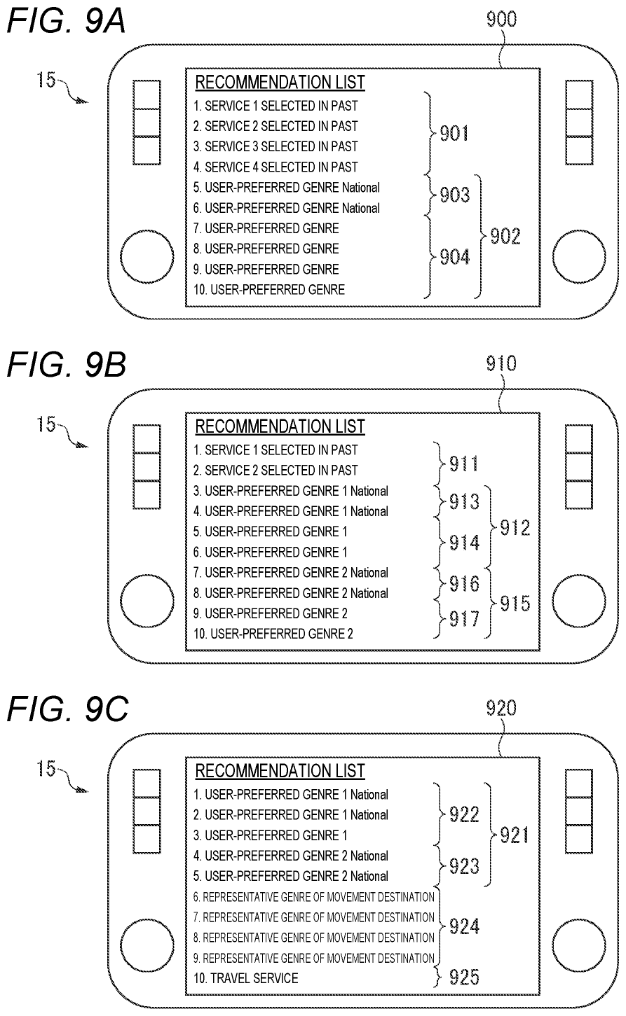

FIGS. 9A, 9B, and 9C are diagrams illustrating display examples of the recommendation list according to the present embodiment. The example of FIG. 9A shows a display example when the recommendation list 900 is generated in steps S705 to S709 in the first recommendation function shown in FIGS. 7A and 7B. Four services 901 (corresponding to the first number in step S705) are shown at the top, and correspond to the services selected by the user in the past. Further, services 902 indicate the services extracted from the genre along the user preference based on the history data of the user. Among these services, services 903 are national broadcasting services, and services 904 are commercial broadcasting services. Here, an example of a case in which the user tends to select the national broadcast rather than the commercial broadcast is shown. Further, in the example of FIG. 9A, a total of 10 services are shown in the recommendation list 900, but additional services may be displayed by switching (for example, scrolling) the screen.

FIG. 9B shows the display example when a recommendation list 910 is generated in steps S710 to S717 in the first recommendation function shown in FIGS. 7A and 7B. Two services 911 (corresponding to the second number in step S710) are shown at the top, and correspond to the services selected by the user in the past. Further, the services 912 indicate the services extracted from the most selected genre based on the past history data of the user. Among these services, services 913 are national broadcasting services, and services 914 are commercial broadcasting services. Similarly, services 915 indicate services extracted from a second most selected genre along the user preference, based on the historical data of the user. Among these services, services 916 are national broadcasting services, and services 917 are commercial broadcasting services. Here, an example of a case in which the user tends to select the national broadcast rather than the commercial broadcast is shown. In the present embodiment, four (corresponding to the predetermined number in step S713) services are extracted for each genre. Further, in the example of FIG. 9B, a total of 10 services are shown in the recommendation list 910, which is used as an upper limit of the recommendation list (corresponding to the threshold value in step S716).

FIG. 9C shows the display example when a recommendation list 920 is generated by the second recommendation function shown in FIG. 8. Four (corresponding to the predetermined number in step S803) services 921 are shown at the top, and correspond to the services extracted in the processes of steps S801 to S803 in FIG. 8. Among the services 921, services 922 and services 923 are services of different genres, and two genres are extracted here. Further, services 924 indicate representative services of a movement destination, and correspond to the services extracted in the processes of steps S804 to S805. Here, four (corresponding to the predetermined number in step S805) services are shown. A service 925 indicates the service of the predetermined genre (here, a genre related to travel), and corresponds to one service (corresponding to the predetermined number in step S806) extracted in the process of step S806 in FIG. 8.

### (Modification of UI Display)

In the above example, a display example of the UI screen in a list format is shown. However, another display format may be used. Examples of other display formats are shown below.

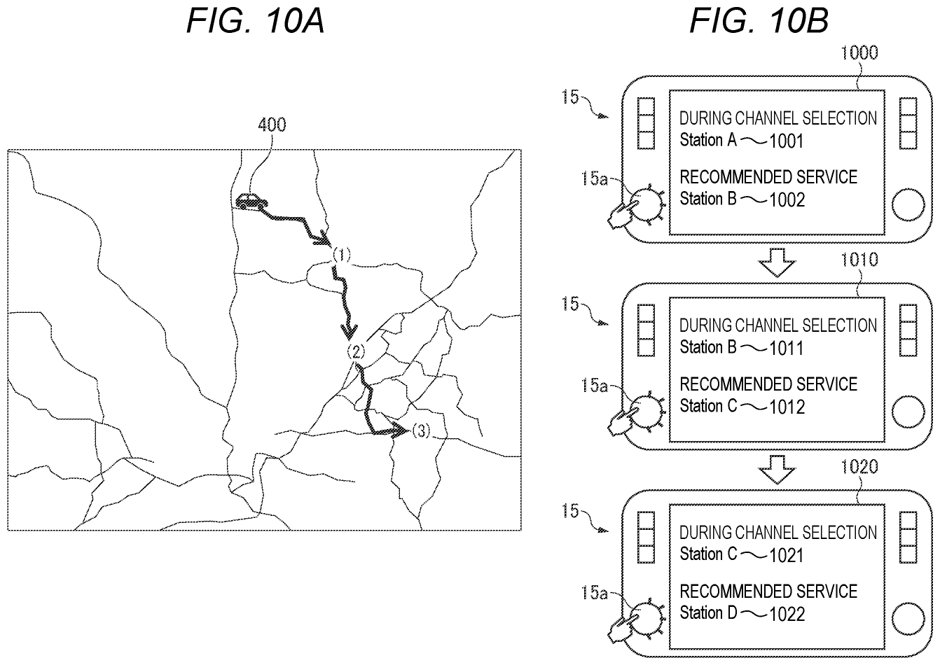

FIGS. 10A and 10B show a display example of the UI screen when only one service specified based on the user preference is provided. The one service provided here may be a service located at the top of the recommendation list generated by the above method. As shown in FIG. 10A, it is assumed that the vehicle 400 moves in an order of a position (1), a position (2), and a position (3), and selectable services change at each position. In this case, as shown in FIG. 10B, on a UI screen 1000, a service B1002 is provided according to the user preference or the like at a time when the vehicle is at the position (1) while a service A1001 is currently selected. In this case, when the user gives an instruction to switch to the provided service B1002 via an operation button 15a, the service A1001 is switched to the service B1002.

Similarly, on a UI screen 1010, a service C1012 is provided according to the user preference or the like at a time when the vehicle is at the position (2) while a service B1011 is currently selected. In this case, when the user gives an instruction to switch to the provided service C1012 via the operation button 15a, the service B1011 is switched to the service C1012. Further, on a UI screen 1020, a service D1022 is provided according to the user preference or the like at a time when the vehicle is at the position (3) while a service C1021 is currently selected. In this case, when the user gives an instruction to switch to the provided service D1022 via the operation button 15a, the service C1021 is switched to the service D1022.

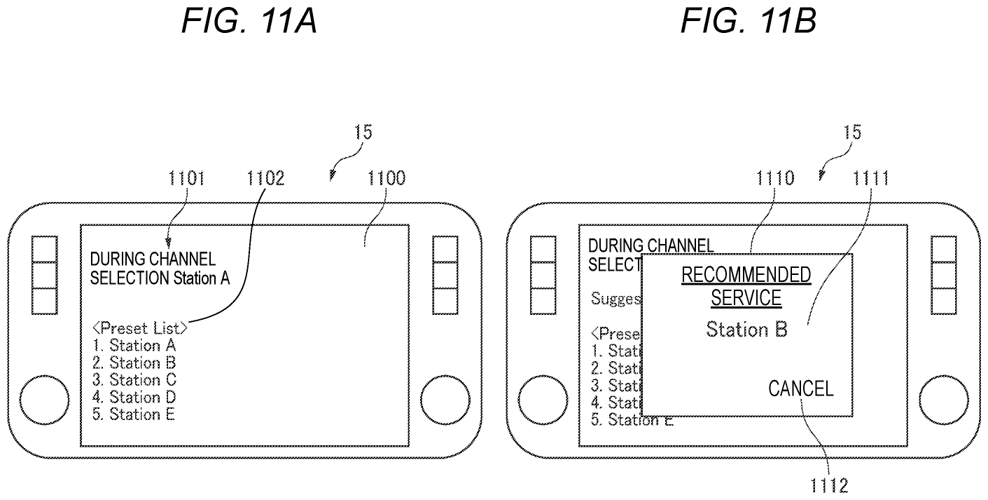

FIGS. 11A and 11B show a display example of the UI screen when the service specified based on the user preference is displayed on a pop-up screen. The one service provided here may be a service located at the top of the recommendation list generated by the above method. As shown in FIG. 11A, a currently selected service A1101 and a list 1102 of services set in advance by the user are displayed on a UI screen 1100. Further, as shown in FIG. 11B, at any timing, the service is extracted based on the user preference, and a recommended service B1111 is displayed on a pop-up screen 1110. When the user does not wish to switch to the recommended service, by instructing a cancel button 1112, it is possible to hide the pop-up screen 1110 and continue using the currently selected service. The pop-up screen 1110 may be switched to non-display when a certain amount of time lapses since the pop-up screen 1110 is displayed, or when the recommended service cannot be selected.

As described above, according to the present embodiment, an in-vehicle radio device (for example, 1) includes: an antenna (for example, 10) configured to receive radio signals; a derivation unit (for example, 13, 210, and 211) configured to derive preference information of a user based on service channel selection history of the user; a calculation unit (for example, 13, 210, and 212) configured to calculate information indicating a size of a reception area for each of a plurality of services that are selectable by the radio signals received by the antenna; an extraction unit (for example, 13, 210, and 213) configured to extract one or more services recommended from the plurality of services that are selectable by the radio signals received by the antenna, based on the preference information and the information indicating the size of the reception area; and a display control unit (for example, 15 and 204) configured to provide the one or more services extracted by the extraction unit on a screen. Accordingly, in the service channel selection, it is possible to provide, with a simple configuration, user-preferred service candidates while reducing the burden of the channel selection of the user. In particular, since the user-preferred services are provided based on information broadcast as the radio signals, additional equipment such as Internet connection is not required, and the simple configuration can be achieved.

The information indicating the size of the reception area is based on the number of network stations that broadcast the same service. Accordingly, it is possible to predict the size of the reception area of the service based only on the broadcast information of the radio signal.

The information indicating the size of the reception area is based on error correction information used when the same service is broadcast. Accordingly, it is possible to predict the size of the reception area of the service based only on the broadcast information of the radio signal.

The preference information is derived based on at least one of information on a genre, a reception area, and a broadcasting entity of a service indicated by the channel selection history of the user. Accordingly, based on various criteria, it is possible to derive the preference of the user when a service is selected.

The in-vehicle radio device further includes a position information receiving unit (for example, 13, 16, or 202) configured to receive position information of a vehicle on which the in-vehicle radio device is mounted, and the extraction unit switches a criterion for extracting the service based on a current position of the vehicle. Accordingly, it is possible to switch the criterion for service candidates to be provided to the user according to a position of the in-vehicle radio device.

The criterion is based on at least one of a genre having a high frequency of channel selection in the channel selection history of the user, a genre of the largest number of services among services that are selectable by currently received radio signals, and a predetermined genre. Accordingly, according to the position of the in-vehicle radio device, it is possible to provide, to the user, the extracted services using a genre based on the user preference, a popular genre of a visited destination, and a genre that provides useful information during a visit as the criterion for the service candidates provided to the user.

The extraction unit switches an upper limit number of services to be displayed on the screen based on the preference information of the user. Accordingly, according to the position of the in-vehicle radio device, it is possible to switch the upper limit number of service candidates to be provided to the user, and it is possible to maintain the visibility of the candidates.

The extraction unit further sorts the extracted one or more services such that a broadcasting entity having a high frequency of channel selection performed by the user, which is specified by the channel selection history of the user, is ranked higher, and sets the sorted services on the screen. Accordingly, for example, based on whether the service is a national broadcast or a commercial broadcast, it is possible to preferentially provide the service that the user tends to select.

### Other Embodiments

In the above embodiment, the example of extracting the service based on the user-preferred genre is shown. However, the present invention is not limited thereto, and the recommendation list may be generated based on, for example, information related to a sound quality of the radio signal (reception intensity, codec, bit rate, and the like) or other information. When the recommendation list is displayed, not only a name of the service but also information such as music used in the service may be provided.

Depending on the number of services that can be displayed in the recommendation list on the UI screen, a configuration may be used in which services of genres that the user does not normally select are extracted and displayed at a certain probability or ratio.

When the recommendation list is generated in each of steps S606, S607, and S608 of FIG. 6, the recommendation list may be generated excluding the currently selected service. Further, a service to be disposed at the top of the recommendation list may be determined based on the genre of the currently selected service.

It is also possible to implement a process in which programs and applications for implementing the functions of the one or more embodiments described above are supplied to a system or device using a network, storage medium, or the like, and are read and executed by one or more processors in a computer of the system or device.

The process may be implemented by a circuit (for example, application specific integrated circuit (ASIC) or field programmable gate array (FPGA)) that implements one or more functions.

Although various embodiments have been described above with reference to the drawings, it is needless to say that the present disclosure is not limited to such examples. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the various embodiments described above may be combined freely in a range without deviating from the spirit of the disclosure.

### INDUSTRIAL APPLICABILITY

The present disclosure is useful as an in-vehicle radio device and a service channel selection candidate providing method.

What is claimed is:

1. An in-vehicle radio device comprising a memory in which a program is stored, a processor coupled to the memory and configured to perform processing by executing the program, and an antenna configured to receive radio signals, wherein
the processing includes:
deriving preference information of a user based on service channel selection history of the user;
calculating information indicating a size of a reception area for each of a plurality of services that are selectable by the radio signals received by the antenna;
extracting one or more services recommended from the plurality of services that are selectable by the radio signals received by the antenna, based on the preference information and the information indicating the size of the reception area; and
displaying the one or more extracted services on a screen.

2. The in-vehicle radio device according to claim 1, wherein
the information indicating the size of the reception area is based on the number of network stations that broadcast the same service.

3. The in-vehicle radio device according to claim 1, wherein
the information indicating the size of the reception area is based on error correction information used when the same service is broadcast.

4. The in-vehicle radio device according to claim 1, wherein
the preference information is derived based on an information on a genre of a service indicated by the channel selection history of the user.

5. The in-vehicle radio device according to claim 1, wherein
the preference information is derived based on an information on a reception area of a service indicated by the channel selection history of the user.

6. The in-vehicle radio device according to claim 1, wherein
the preference information is derived based on an information on a broadcasting entity of a service indicated by the channel selection history of the user.

7. The in-vehicle radio device according to claim 1, further comprising:
a position information receiving unit configured to receive position information of a vehicle on which the in-vehicle radio device is mounted, wherein
the extraction unit switches a criterion for extracting the service based on a current position of the vehicle.

8. The in-vehicle radio device according to claim 7, wherein
the criterion is based on at least one of a genre having a high frequency of channel selection in the channel selection history of the user, a genre of the largest number of services among services that are selectable by currently received radio signals, and a predetermined genre.

9. The in-vehicle radio device according to claim 1, wherein
the extraction unit switches an upper limit number of services to be displayed on the screen based on the preference information of the user.

10. The in-vehicle radio device according to claim 1, wherein
the extraction unit further sorts the extracted one or more services such that a broadcasting entity having a high frequency of channel selection performed by the user, which is specified by the channel selection history of the user, is ranked higher, and sets the sorted services on the screen.

11. A service channel selection candidate providing method comprising:
deriving preference information of a user based on service channel selection history of the user;
calculating information indicating a size of a reception area for each of a plurality of services that are selectable by radio signals received by an antenna;
extracting one or more services recommended from the plurality of services that are selectable by the radio signals received by the antenna based on the preference information and the information indicating the size of the reception area; and
displaying the one or more extracted services on a screen.

12. A tangible computer readable storage medium that stores a computer program, the computer program, when executed by a processor, causing a computer apparatus to perform a process comprising:
deriving preference information of a user based on service channel selection history of the user;
calculating information indicating a size of a reception area for each of a plurality of services that are selectable by the radio signals received by an antenna;
extracting one or more services recommended from the plurality of services that are selectable by the radio signals received by the antenna, based on the preference information and the information indicating the size of the reception area; and
displaying the one or more extracted services on a screen.
